(19) United States
(12) Patent Application Publication
(10) Pub. No.: US 2022/0307697 A1
(43) Pub. Date: Sep. 29, 2022

(54) COOKING DEVICE

(71) Applicant: Future Burger Corp., Toronto (CA)

(72) Inventors: Shlomo Piontkowski, New York, NY (US); Pnina Piontkowski, New York, NY (US); Sharone Piontkowski, New York, NY (US)

(73) Assignee: Future Burger Corp., Toronto (CA)

(21) Appl. No.: 17/691,226

(22) Filed: Mar. 10, 2022

Related U.S. Application Data
(60) Provisional application No. 63/165,430, filed on Mar. 24, 2021.

(51) Int. Cl. F24C 15/00; A47J 43/18; A23L 5/10

(52) U.S. Cl. CPC F24C 15/003; A47J 43/18; A23L 5/13

(57) ABSTRACT

A cooking device including an aroma generator, needle base plate, aroma needle, and a plurality of perforation needles is provided. The aroma generator is operatively connected to an upper electric motor. The cooking device further includes an upper perforated plate, upper grilling plate and lower grilling plate. The lower grilling plate is operatively connected to a lower electric motor. A method for using a cooking device to prepare a vegetarian and/or vegan meat substitute product having a flavoring, aroma and texture comparable to traditional meat-based food products is further provided.

### RELATED APPLICATIONS

This application claims the benefit of U.S. Provisional Patent Application No. 63/165,430, filed Mar. 24, 2021 and entitled “COOKING DEVICE,” the entire contents of which are expressly incorporated herein by reference.

### FIELD OF THE INVENTION

The exemplary embodiments of the present invention relate generally to a grilling apparatus and, more specifically, to a flavoring, aroma and texture generating grilling apparatus in connection with meat products, such as, for example, vegetarian and/or vegan meat substitute products.

### BACKGROUND OF THE DISCLOSURE

Cooking can be made simple, healthy, rewarding and cost-effective. Generally speaking, foods we enjoy are likely to be those we eat more frequently. Taste, odor and texture of foods should be prioritized when preparing nutritious and satisfying meals.

Conventional cooking is not only an art, but also a science and a craft. Cooking techniques and ingredients vary widely, ranging from open-fire grilling, use of electric stoves, and baking. These techniques reflect unique environmental, economic, and cultural traditions and trends. A particular cooking style may depend in part on the skill and training of a cook.

Grilling involves application of dry heat to food, usually through direct conduction. Grilling cooks meat and vegetables quickly by applying a significant amount of direct or radiant heat at high temperatures, often in excess of 260° C. (500° F.). Such high temperatures provide food with aroma and flavor through a chemical process known as the Maillard reaction.

Many food types are often grilled, including meat and non-meat food product patties. For example, a non-meat patty, commonly rereferred to as a veggie burger, does not contain meat and may include ingredients such as, e.g., soybeans, tofu, nuts, grains, seeds, and fungi, such as mushrooms or mycoprotein. Such non-meat patties are intended to imitate meat, but often lack flavors and palatable textures inherent in meat patties.

There is thus a need for a method of preparing and cooking food product patties that address these and other disadvantages of the prior art.

### BRIEF SUMMARY OF THE DISCLOSURE

Various embodiments of the present disclosure provide a flavoring and aroma grilling apparatus for preparing food that retains the nutritional integrity, while providing satisfying flavor and aromas. In accordance with an exemplary embodiment of the subject disclosure, a cooking device is provided. The cooking device includes an aroma generator, the aroma generator incluidng a reservoir, an engine operatively connected to the reservoir, a fan operatively connected to the reservoir atop the engine, in which the engine is configured to power the fan, the fan configured to direct the mist throughout and out of the reservoir, and a piezoelectric transducer, the piezoelectric transducer located within the reservoir on a bottom side of the reservoir; an aroma needle configured to draw a liquid into the reservoir, in which the piezoelectric transducer is configured to generate a mist from the liquid as an electric current is applied; a housing operatively connected to the aroma generator, the housing including an upper electric motor operatively connected to the aroma generator, a base plate operatively connected to the upper electric motor, a plurality of perforation needles mounted on the base plate, an upper perforation plate, the upper perforated plate having a plurality of apertures, an upper grilling plate below the upper perforation plate, a pellet, the pellet located in between the upper perforation plate and the upper grilling plate, and a lower grilling plate located below the pellet; and a controller, the controller including a processor and a display, in which the upper grilling plate, and the lower grilling plate have a similar shape.

In accordance with an aspect of the subject disclosure, the aroma needle further includes a sleeve, the sleeve configured to circumscribe the aroma needle.

In accordance with another aspect of the subject disclosure, a diameter of the sleeve is larger than a diameter of the aroma needle.

In accordance with still another aspect of the subject disclosure, the cooking device further including a gap between the sleeve and the aroma needle.

In accordance with yet another aspect of the subject disclosure, the sleeve is configured as a drive mechanism to biase the base plate in a direction towards the upper perforated plate.

In accordance with still another aspect of the subject disclosure, the base plate further includes a central through hole.

In accordance with yet another aspect of the subject disclosure, the upper grilling plate further includes a plurality of recesses, the plurality of recesses of the upper grilling plate being coaxial with the longitudinal axis of each of the plurality of perforation needles.

In accordance with still another aspect of the subject disclosure, the pellet includes an aroma pellet and a flavor pellet, the aroma pellet placed within a recess of the flavor pellet.

In accordance with yet another aspect of the subject disclosure, the upper perforation plate, the upper grilling plate, and the lower grilling plate have one of a rectangular or circular shape.

In accordance with still another aspect of the subject disclosure, the aroma generator is operatively connected to an upper electric motor.

In accordance with yet another aspect of the subject disclosure, the aroma needle extends from the aroma generator through the base plate and provides fluid communication from a distal end of the aroma needle to the reservoir.

In accordance with another exemplary embodiment of the subject disclosure, a method for cooking a food item is provided. The method includes receiving a food item on a first tray of a cooking device, and a pellet on a second tray located above the first tray; setting a cooking parameter for the cooking device; lowering an aroma needle from an original position to penetrate the pellet and retrieve a content within the pellet towards a reservoir of an aroma generator located on the cooking device; heating the retrieved content in the reservoir to generate a mist, and releasing the generated mist to an area outside of the cooking device while retaining a portion of the mist within the reservoir; lowering a plurality perforation needles and a sleeve operatively connected to a base plate to penetrate the pellet and the food item; discharging a flavoring from the pellet to the food item via a plurality of through holes located a length of each of the plurality of perforation needles; cooking and texturizing the food item based on the set parameter; and retracting the aroma needle and plurality of perforation needles to the original position.

In accordance with an aspect of the subject disclosure, the texturizing is performed by rotating a lower grilling plate configured to hold the first tray holding the food item while alternately retracting and reinserting the plurality of perforation needles out of and into the food item by alternately raising and lowering the plurality of perforation needles.

In accordance with still another aspect of the subject disclosure, the placing of the food item on the second tray and the placing of the pellet on the first tray include moving a first tray and a second tray from a first position within a housing of a cooking device to a second position spaced laterally from the housing, placing the food item on the second tray and placing the food item on the first tray while the second tray and the first tray are at the second position, and moving the first tray and the second tray from the second position back to the first position.

In accordance with another exemplary embodiment of the subject disclosure, non-transitory computer readable medium having stored thereon instructions for causing a processing circuitry to perform a process is provided. The process includes receiving a food item on a first tray of a cooking device, and a pellet on a second tray located above the first tray; setting a cooking parameter for the cooking device; lowering an aroma needle from an original position to penetrate the pellet and retrieve a content within the pellet towards a reservoir of an aroma generator located on the cooking device; heating the retrieved content in the reservoir to generate a mist, and releasing the generated mist to an area outside of the cooking device while retaining a portion of the mist within the reservoir; lowering a plurality perforation needles and a sleeve operatively connected to a base plate to penetrate the pellet and the food item; discharging a flavoring from the pellet to the food item via a plurality of through holes located a length of each of the plurality of perforation needles; cooking and texturizing the food item based on the set parameter; and retracting the aroma needle and plurality of perforation needles to the original position.

### BRIEF DESCRIPTION OF THE SEVERAL VIEWS OF THE DRAWINGS

The foregoing summary, as well as the following detailed description of the exemplary embodiments of the subject disclosure, will be better understood when read in conjunction with the appended drawings. For the purpose of illustrating the present disclosure, there are shown in the drawings, exemplary embodiments. It should be understood, however, that the subject application is not limited to the precise arrangements and instrumentalities shown.

FIG. 1 is a side perspective, simplified view of a cooking device in accordance with an exemplary embodiment of the subject disclosure in a closed position;

FIG. 1A is a simplified view of a plurality of through holes of a perforation needle of the cooking device of FIG. 1;

FIG. 2 is a side perspective, simplified view of the cooking device of FIG. 1 in an open position;

FIG. 3 is a side perspective, simplified view of the cooking device of FIG. 1 loaded with a patty and flavor and aroma pellets in a closed position;

FIG. 4 is a side perspective, simplified view of the cooking device of FIG. 1 in a partially compressed position;

FIG. 5 is a side perspective, partially exploded view of the cooking device of FIG. 4 in a fully compressed position;

FIG. 6 is a side perspective, simplified view of the cooking device of FIG. 1 illustrating the extraction of needles from a patty;

FIG. 7 are views of various textured patterns on a patty produced by the cooking device of FIG. 1;

FIG. 8 are perspective views of various textures of a patty produced by the cooking device of FIG. 1;

FIG. 9 is a side perspective, simplified view of the cooking device of FIG. 1 illustrating the removal of a cooked patty;

FIG. 10 is an exploded perspective view of the cooking device of FIG. 1;

FIG. 11 is a side perspective view of flavor and aroma pellets of the cooking device of FIG. 1;

FIG. 12 is a partial exploded perspective view of an aroma generator of the cooking device of FIG. 1;

FIG. 13 are perspective views of various grill bases and various textures of a cooked patty applicable with the subject disclosure; and

FIG. 14 is a flow chart of a method of cooking a food item with the cooking device.

### DETAILED DESCRIPTION OF THE DISCLOSURE

Reference will now be made in detail to the exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

“Exemplary” as used herein shall mean “example” only and is not intended to identify any embodiment or structure as preferred or more desirable than any other.

Throughout this disclosure, various aspects of the exemplary embodiments can be presented in a range format. It should be understood that the description in range format is merely for convenience and brevity and should not be construed as an inflexible limitation on the scope of the exemplary embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments may be combined in any suitable manner in one or more embodiments. One skilled in the relevant art will recognize, in light of the description herein, that the exemplary embodiments can be practiced without one or more of the specific features or advantages of a particular embodiment. In other instances, additional features and advantages may be recognized in certain embodiments that may not be present in all embodiments of the subject disclosure.

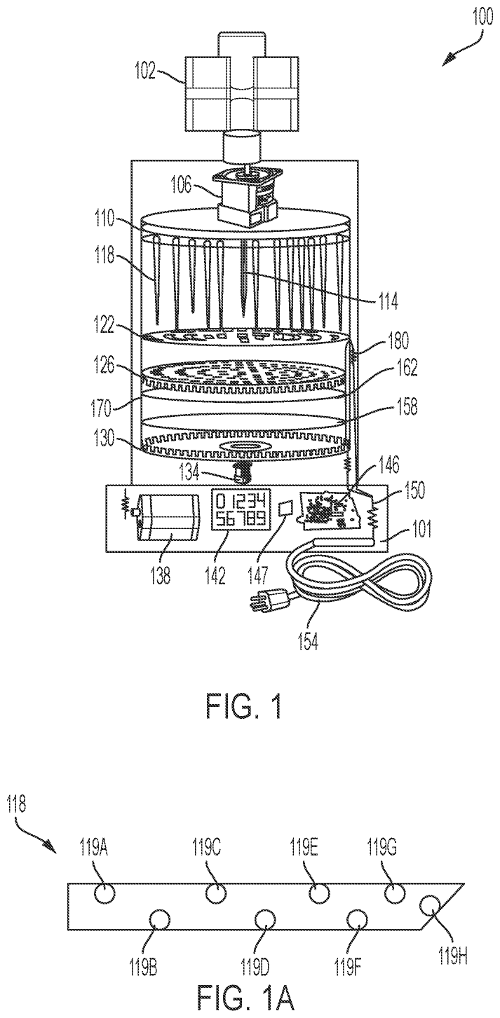

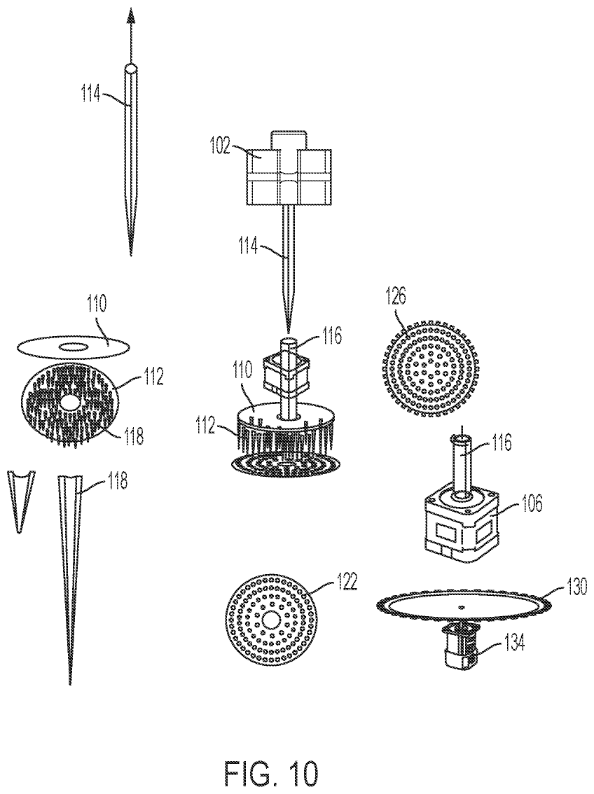

Referring to FIGS. 1-6, 9, 10 and 12, there is shown an exemplary embodiment of a cooking device 100 in accordance with the subject disclosure. As shown in FIG. 1, the cooking device 100 includes an aroma generator 102 operatively connected to an upper electric motor 106. The cooking device 100 further includes needle base plate 110, an aroma needle 114, and a plurality of perforation needles 118. The cooking device 100 also includes an upper perforated plate 122, upper grilling plate 126 and lower grilling plate 130.

Referring now to FIGS. 1, 5, and 12, the aroma generator 102 includes a reservoir 103 above a housing 180 of the cooking device 100, a piezoelectric transducer 107 positioned at the bottom of the reservoir 103, and a pair of engines 108 positioned above the reservoir 103 and driving respective fans 105. Although the embodiments depicted in the Figures include two engines 108 and fans 105, it should be appreciated that any number of fans 105 or engines 108 may be provided, and that various embodiments described and claimed herein are not intended to be limited to any particular number of fans 105 or engines 108. As further discussed in detail below with respect to operation of the cooking device 100, the aroma needle 114 causes a liquid (having a scent of food) to move into the reservoir 103 of the aroma generator 102. When an electric current is applied to the piezoelectric transducer 107, it causes the liquid inside the reservoir 103 to steam and generate mist 104. Thereafter, the fans 105 propel mist 104 outwardly and upwardly into the air adjacent the cooking device 100 where a patty 135 is being cooked, thereby releasing the food scent into and around the cooking area. In an aspect, a portion of the mist 104 remains in the reservoir 103 of the aroma generator 102.

Referring now to FIGS. 1-3, 6, 9 and 10, the upper electric motor 106 is operatively connected to and positioned adjacent the needle base plate 110. Specifically, the upper electric motor 106 is positioned about an upper face of needle base plate 110. Needle base plate 110 includes a plurality of perforation needles 118 extending downwardly from a bottom, inferior and/or lower surface of needle base plate 110. Needle base plate 110 includes a central through hole 117 that passes from the upper surface to the lower surface. The central through hole 117, in an exemplary embodiment, is sized to receive the aroma needle 114 therethrough. A longitudinal axis of the central through hole 117 extends in the same direction, or approximately the same direction, as a longitudinal axis of the aroma needle 114.

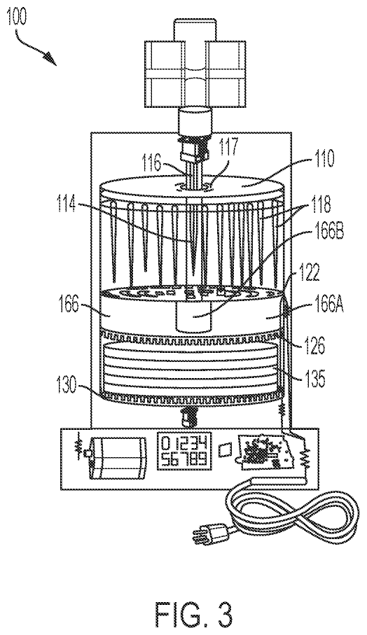

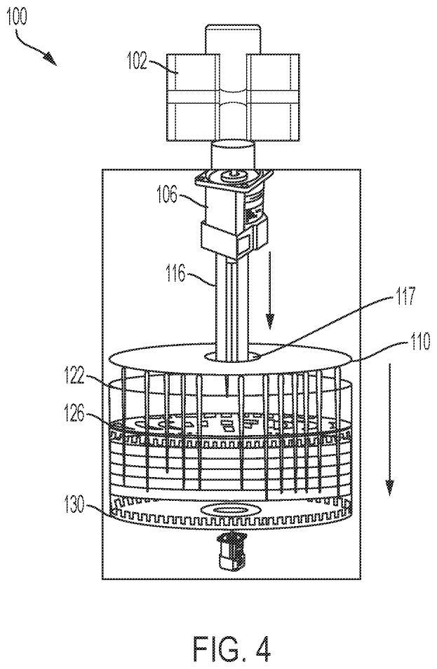

As shown in FIGS. 3 and 4, the aroma needle 114 is operatively connected to upper electric motor 106 and the aroma generator 102. That is, the aroma needle 114 extends downwardly from the aroma generator 102 and extends through needle base plate 110 thereby providing fluid communication from a distal end of the aroma needle 114 to the reservoir 103. Aroma needle 114 further includes a sleeve 116 that circumscribes the aroma needle 114. The diameter of the sleeve 116 is larger than a diameter of the aroma needle 114 such that there is a gap between the sleeve 116 and aroma needle 114. As further discussed below, the sleeve 116 circumscribing the aroma needle 114 causes the sleeve 116 to serve as a drive mechanism biasing (i.e., pulling) the needle base plate 110 downwardly. The drive mechanism can be configured as a screw drive or other suitable drive mechanism suitable for moving the needle base plate 110 linearly.

Referring back to FIG. 1, the cooking device 100 includes upper perforated plate 122, upper grilling plate 126 and lower grilling plate 130. As described herein, upper perforated plate 122, upper grilling plate 126 and lower grilling plate 130 are preferably configured as circular plates. Alternatively, they can be configured as any other shape suitable for their intended purpose, such as a square, rectangle and the like. It is to be understood that these plates 122, 126, 130 may have a similar overall shape and configuration.

The upper perforated plate 122 includes a plurality of apertures and/or through holes for receiving the plurality of perforation needles 118 therethrough. That is, the plurality of apertures on upper perforated plate 122 are coaxial with a longitudinal axis of the respective perforation needles 118 such that the perforation needles 118 pass therethrough. Similarly, upper grilling plate 126 also includes a plurality of apertures and/or recesses for receiving the plurality of perforation needles 118 therethrough. That is, the plurality of apertures on upper grilling plate 126 are coaxial with the longitudinal axis of the respective perforation needles 118 such that the perforation needles 118 pass therethrough. In other words, the apertures on upper perforated plate 122 and upper grilling plate 126 are aligned such that the plurality of perforation needles 118 pass through both plates during operation of the cooking device 100.

Referring to FIGS. 1 and 1A, in accordance with an exemplary embodiment, each of the plurality of perforation needles 118 includes a plurality of laterally facing through holes 119A-H. For example, the perforation needles 118 can each include first, second and third through holes 119A-C (FIG. 1A) circumferentially spaced about the perforation needle 118 and along the length of the perforation needle 118. When the perforation needles 118 are inserted into a patty 135, as further described below, the through holes 119 A-H facilitate cutting and milling a patty 135. Additionally, when the upper perforated plate 122 squeezes a flavor pellet 166A, the liquid contents of the flavor pellet 166A can enter an upper portion of the perforation needles 118 and subsequently move down toward a bottom (i.e., distal) portion of the perforation needles 118 in contact with the patty 135. It is to be understood that the outer surface of the perforation needles 118 can alternatively include corrugations, straight flutes, spiral flutes, ribs and/or protrusions. In an aspect, the plurality of perforation needles 118 can have flutes that extend a longitudinal length of the needle.

The lower grilling plate 130 is configured as a solid circular plate. The lower grilling plate 130 is connected to lower electric motor 134. Specifically, the lower electric motor 134 is mounted on a bottom, inferior and/or lower surface of lower grilling plate 130. Alternatively, the lower grilling plate 130 is mounted onto lower electric motor 134. During operation of the cooking device 100, the lower electric motor 134 rotates the lower grilling plate 130 in a clockwise or counterclockwise direction.

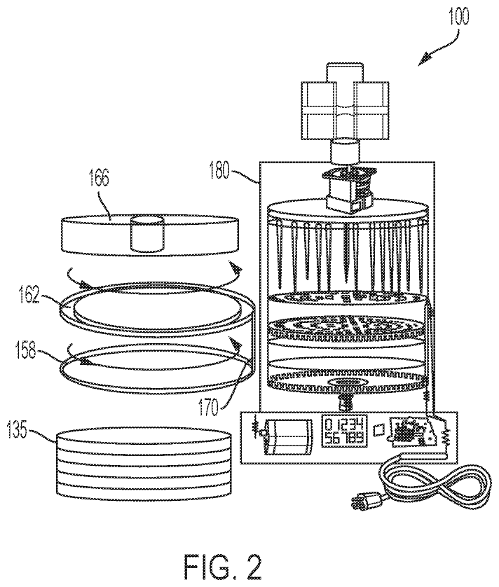

Referring now to FIG. 2, the cooking device 100 includes a first tray 158 and a second tray 162. The first tray 158 is shaped and configured to receive a generic uncooked patty (i.e., food item) 135. The second tray 162 is sized and shaped to receive pellets 166. As described herein, the first tray 158 and the second tray 162 include similar features and a discussion of such features will be applicable to both first and second trays, unless stated otherwise. The first and second trays 158, 162 are each configured as a circular plate with multiple sized apertures and/or recesses designed to receive and secure the patty 135 or pellets 166. Alternatively, the first and second trays 158, 162 can be configured with any other shape suitable for their intended purpose, such as a square, rectangle and the like.

In an exemplary aspect, the first and second trays 158, 162 are pivotably connected to a lateral side of the housing 180 of the cooking device 100 by a hinge 170, as best shown in FIG. 2. The first and second trays 158, 162 move between a first position (as shown in FIG. 1), where the first and second trays 158, 162 are contained within housing 180 of the cooking device 100, and a second position (as shown in FIG. 2) spaced apart from the first position where the first and second trays 158, 162 are spaced laterally from the housing 180. In an aspect, the cooking device 100 can include a fastener (not shown) for releasably securing the first and second trays 158, 162 in the first position during the operation of the cooking device 100. The fastener can be configured as any suitable attachment member such as a clip, a hook and loop fastener, a strap, a hook, and the like.

Before the cooking device 100 is activated, the first tray 158 and the second tray 162 are moved to the second position (FIG. 2) for loading the patty 135 and pellets 166. The patty 135 is placed on first tray 158. Similarly, pellets 166 are placed on the second tray 162. Thereafter, the first tray 158 and the second tray 162 are rotated via hinge 170 back into the first position (i.e., in their designated slots within the cooking device 100), as best shown in FIG. 3. That is, the pellets 166 are positioned between upper perforated plate 122 and upper grilling plate 126, and the patty 135 is positioned between upper grilling plate 126 and lower grilling plate 130.

As shown in FIGS. 2 and 3, the patty 135 can be configured as a standard or universal non-meat based patty 135 capable of being customized with a pre-determined taste and smell based on the preference of an individual user. For example, the standard patty 135 can be configured as a layered tofu patty with varying levels of hardness and texture. Alternatively, it can be configured as a sphere or sausage shape with varying layers of hardness and texture.

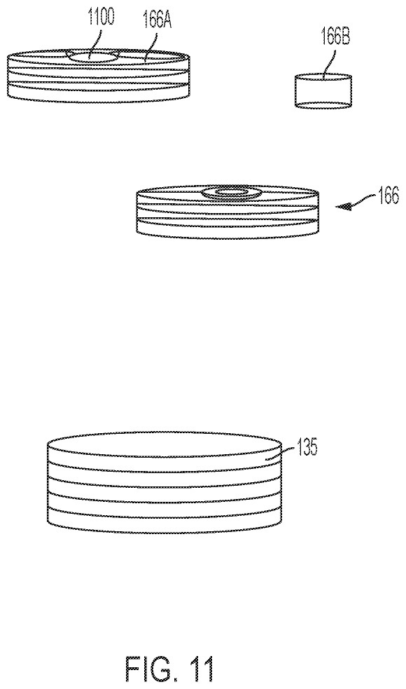

Referring now to FIGS. 3 and 11, the pellets 166 includes flavor pellet 166A and aroma pellet 166B. As shown in FIG. 11, the aroma pellet 166B is placed within a recess 1100 of the flavor pellet 166A such that the flavor pellet 166A is circumscribed by the aroma pellet 166B. The flavor pellet 166A and the aroma pellet 166B can be customized based on complementary taste and smell attributes and user preference. For example, complementary taste and smells can be pre-selected by well recognized chefs or culinary artists in respective areas of the industry. Consumer demand can drive further modifications in the future to customize the different combinations of tastes and smells. In an aspect, the flavor pellet 166A and the aroma pellet 166B can be customized to reflect the taste and smell of spicy barbecue chicken or a well-done meat hamburger.

Referring back to FIG. 1, it is contemplated that the cooking device 100 further includes a control unit 101 operatively connected to the components of the cooking device 100 discussed above including but not limited to aroma generator 102, upper electrical motor 106, needle base plate 110, upper perforated plate 122, upper grilling plate 126, lower grilling plate 130 and lower electrical motor 134 via a plurality of insulated wires 150.

In an aspect of the exemplary embodiment, the control unit 101 includes a circuit board 146 and processor 147 for processing or executing a plurality of algorithms or computer instructions based on artificial intelligence technology to obtain a desired patty 135 consistency unique to a particular individual or to automatically adjust parameters during operation of the cooking device 100 in real time. The processor 147 can also be configured to include computer instructions to operate time, temperature and pressure of the cooking device 100 based on user specific parameters for texture, hardness, temperature and spice levels. Additionally, when the cooking device 100 is in operation, the amount of time remaining until completion or the temperature of the grill can be displayed on a display device 142 on the control unit 101. Alternatively, a user may be able to use the control unit 101 to program the cooking device 100 with a customized recipe. In another aspect of the exemplary embodiment, the cooking device 100 can be operated on conventional 110V electricity transmitted through an electric cord 154 plugged into an appropriate area of a home. Alternatively, the cooking device 100 can operate on a standalone battery 138.

Prior to operation of the cooking device 100, the user loads the uncooked patty 135 and the pellets 166 including the flavor pellet 166A, and the aroma pellet 166B onto the first and second trays 158, 162. The first and second trays 158, 162 are returned to the closed position such that the patty 135 and the flavor pellet 166A, and the aroma pellet 166B are contained within the cooking device 100.

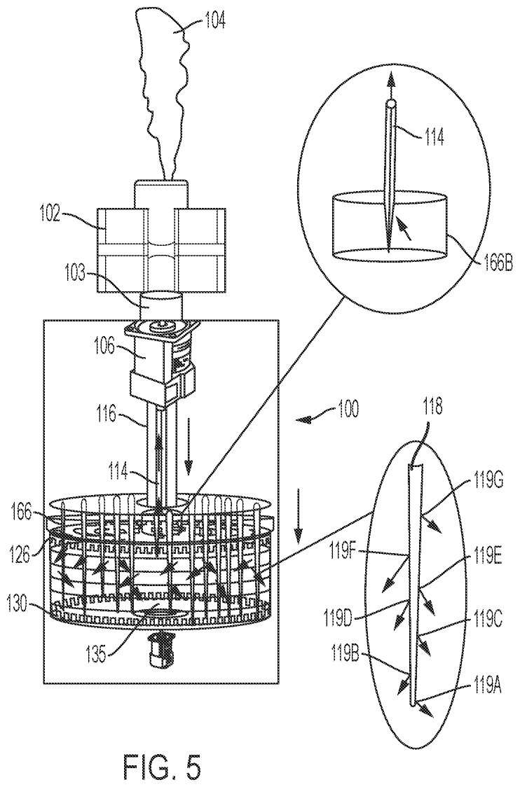

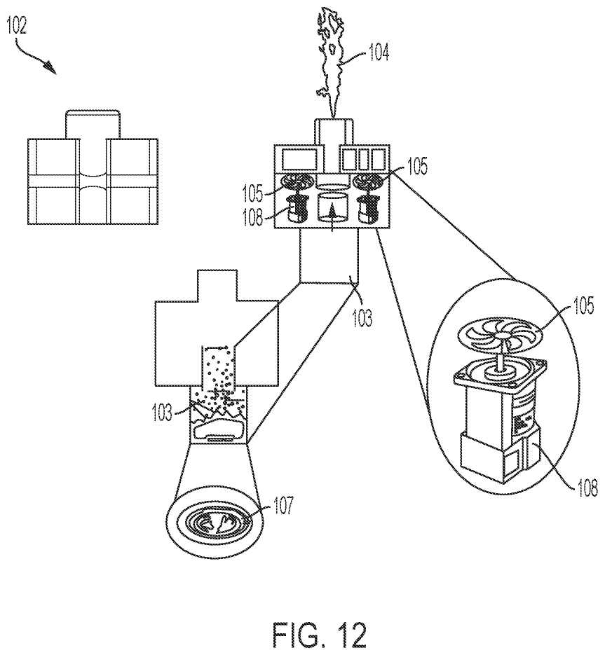

Referring now to FIG. 5 and FIG. 12, the aroma needle 114 is lowered such that the aroma needle 114 penetrates the aroma pellet 1666 causing the contents of the aroma pellet 166B to flow upward along the sleeve 116 and inside the aroma needle 114 under pressure. As a result, the contents of the aroma pellet 166B moves into reservoir 103 of the aroma generator 102. Specifically, as the aroma pellet 166B is punctured by the aroma needle 114, the liquid contents of the aroma pellet 166B is directed into reservoir 103. In reservoir 103, a fine particle mist 104 is generated by the piezoelectric transducer 107 responding to electric currents which produce ultrasonic waves in selective ceramics to drive the ultrasonic nozzle of the aroma generator 102. The pair of engines 108 propel respective fans 105 to release the mist 104 into the surrounding area, thereby emitting a desired odor associated with operation of the cooking device 100.

Referring now to FIGS. 3-6, the upper electric motor 106 drives sleeve 116 downward. As the diameter of sleeve 116 is larger than through hole 117, needle base plate 110 is also biased downward along with the plurality of perforation needles 118. The perforation needles 118 then pass through the apertures of upper perforated plate 122. Thereafter, the perforation needles 118 penetrate and traverse through flavor pellet 166A. After piercing through the flavor pellet 166A, the perforation needles 118 proceed to pass through the apertures of upper grilling plate 126 until the perforation needles 118 penetrate the patty 135 positioned below the upper grilling plate 126. As shown in FIG. 5 and previously discussed, the flavor pellet 166A discharges flavoring and spices under pressure into the patty 135 via a plurality of through holes 119 located along a length of each of the plurality of perforation needles 118.

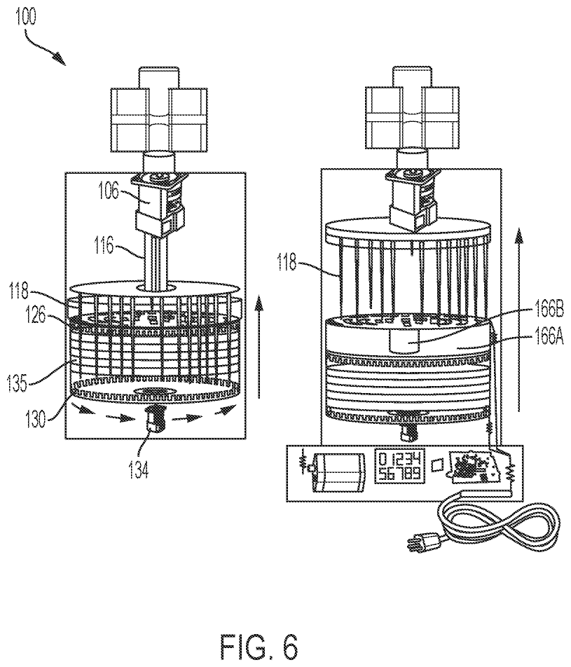

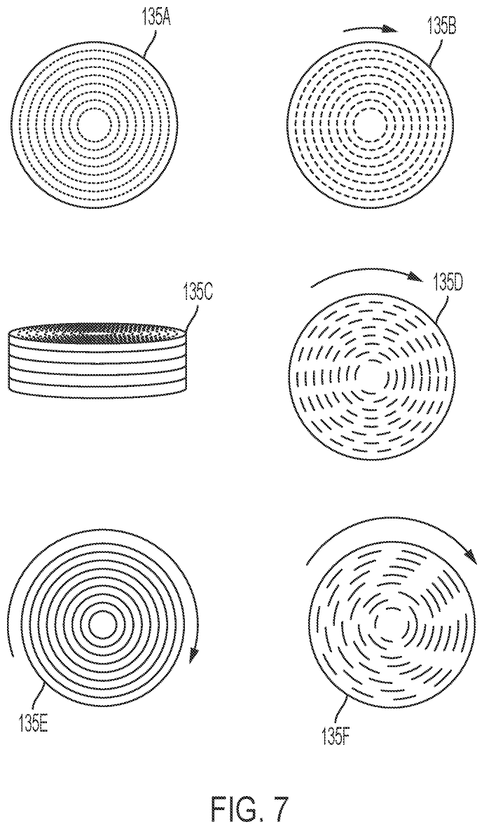

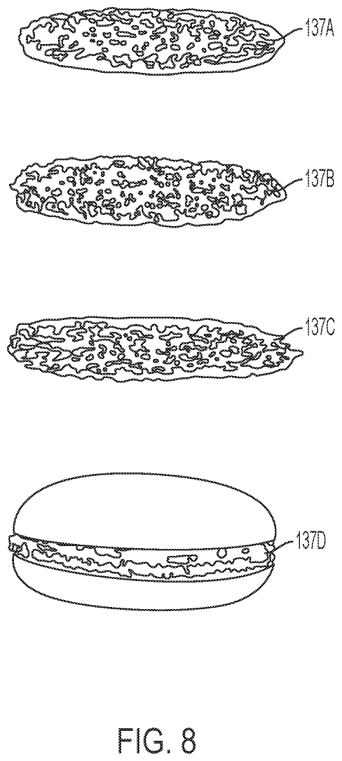

While the desired aroma is being released and the patty 135 is being infused with flavor and spices, the upper grilling plate 126 and lower grilling plate 130 are activated for a predetermined amount of time and magnitude to cook the patty 135 that has been infused with flavor and spices. In addition to cooking, the patty 135 is also being texturized using the plurality of perforation needles 118 that remain partially or fully implanted in the patty 135. That is, as shown in FIG. 6, lower electric motor 134 rotates lower grilling plate 130 and the patty 135 in a clockwise or counterclockwise manner. As the patty 135 rotates, the through holes 119 of the perforation needles 118 cuts and mills the patty 135 to a desired texture. For example, in FIG. 7, there are shown various desired textures 135A-F for the patty 135 including mild texturing 135B, medium texturing 135D, severe texturing 135F, or a ground texture 135E. FIG. 8 shows a variety of textured patties 137A-D following grilling, spicing and texturing in the cooking device 100.

In accordance with an aspect of the exemplary embodiment, the plurality of perforation needles 118 can be removed from the patty 135 and reinserted into the patty 135 after the patty 135 has been rotated. This process can be repeated any number of times to achieve a desired texturing such as angled perforations and the like.

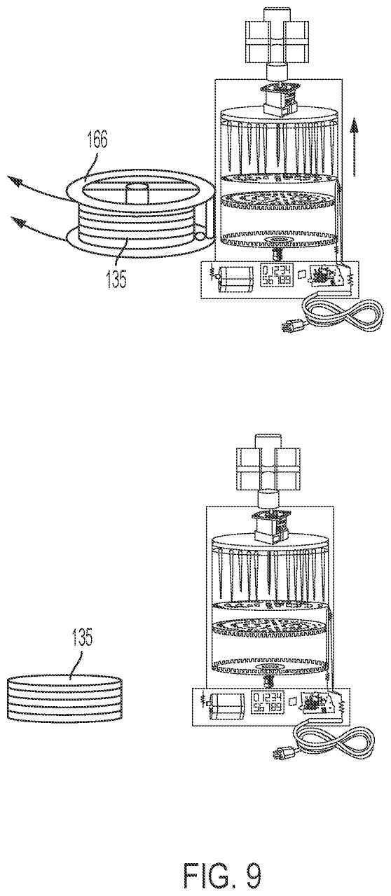

After the desired flavoring, texturing and cooking is completed, the aroma needle 114 and plurality of perforation needles 118 are fully retracted and returned to their original position (FIG. 6). As shown in FIG. 9, the cooked patty 135 is ready to be served with a desired level of grilling, flavoring, spices and texture. The first and second trays 158, 162 are moved to the open position to allow for removal of the cooked patty 135 and the empty pellets 166 from the cooking device 100.

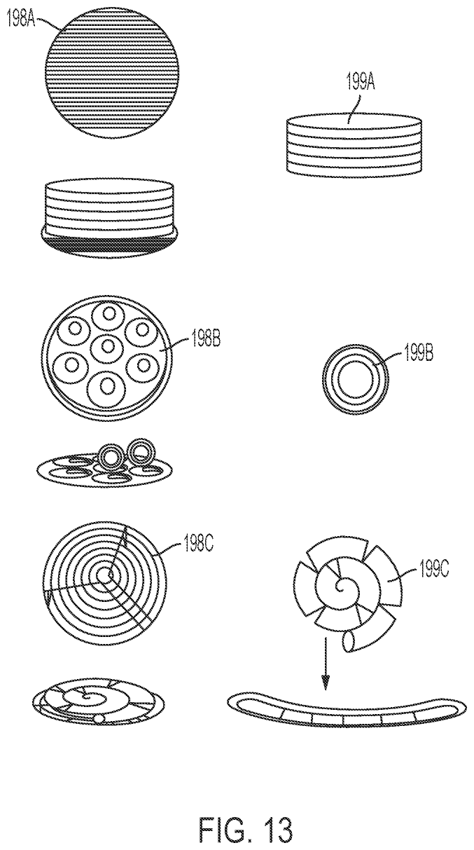

It is to be understood that the cooking device 100 can be further customized based on a desired texture or shape. For example, as shown in FIG. 13, a plurality of exchangeable grilling plates can be utilized to achieve a desired output such as fluted 198A, circular 1986 or spiral 198C shapes that correspond to a layered patty 199A, a falafel ball 1996, or a sausage patty 199C resembling a hot dog.

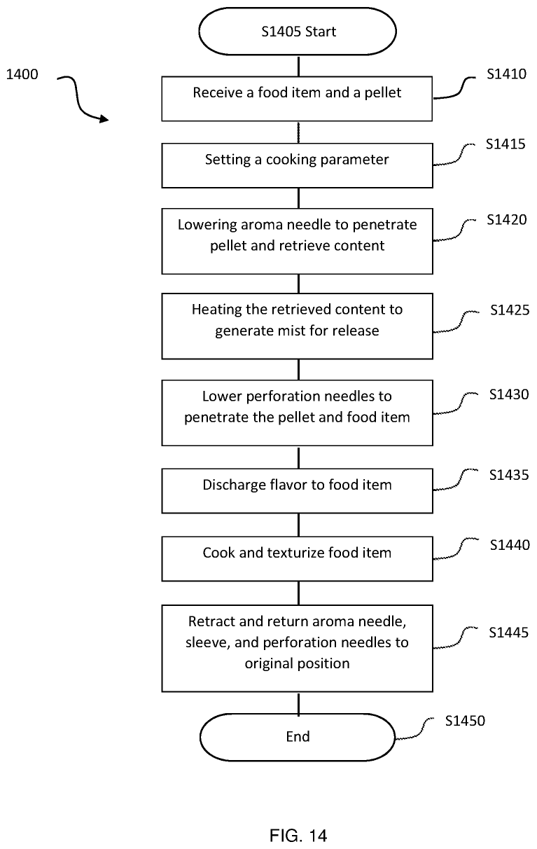

The subject disclosure also describes a method for using a cooking device 100 to prepare a vegetarian and/or vegan meat substitute product having a flavoring, aroma and texture comparable to meat-based products. Referring to FIG. 14, there is shown a flow diagram of a process 1400 of cooking a food item 135 with the cooking device 100 is shown. The process 1400 starts at S1410, where a food item 135 and pellets 166 are received on a first tray 158 and a second tray 162 located above the first tray 158 of a cooking device 100, respectively. This may be done by moving the first tray 158 and the second tray 162 from a first position (i.e., a closed position) within a housing 180 of a cooking device 100 to a second position (i.e., an open position) spaced laterally from the housing 180. At the second position, both the food item 135 and the pellets 166 may be put on the respective first tray 158 and second tray 162. After receiving the food item 135 and the pellets 166, the first tray 158 and the second tray 162 are moved back from the second position to the first position.

Afterwards, at S1415, a cooking parameter for the cooking device 100 is set. Next, at S1420, an aroma needle 114 is lowered from an original position to penetrate the aroma pellet 166B and retrieve a content (e.g., fluid or juices) from the aroma pellet 166B towards a reservoir 103 of an aroma generator 102 located on the cooking device 100. Then, at S1425, the retrieved content in the reservoir 103 is heated to generate a mist 104, whereby the generated mist 104 is released to an area outside of the cooking device 100 while retaining a portion of the mist 104 within the reservoir 103.

Thereafter, at S1430 a plurality perforation needles 118 and a sleeve 116 operatively connected to a base plate 110 are lowered by the upper electric motor 106 to penetrate the flavor pellet 166A and then to the food item 135. Next, at S1435, flavoring from the flavor pellet 166A is discharged to the food item 135 via a plurality of through holes 119A-H located throughout a length of each of the plurality of perforation needles 118. Here, the flavoring may include spices, herbs, or sauce.

Then at S1440, the food item 135 is cooked and texturized. Texturizing is performed by rotating a lower grilling plate 130 configured to hold the first tray 158 holding the food item 135 by the lower electric motor 134, and alternately retracting and reinserting (i.e., raising and lowering) the plurality of perforation needles 118 out of and into the food item 135 by alternatively raising and lowering the plurality of perforation needles 118.

At, S1445 the aroma needle 114 and plurality of perforation needles 118 are retracted to the original (i.e., raised) position. The process 1400 then ends at S1450.

It will be appreciated by those skilled in the art that changes could be made to the exemplary embodiments described above without departing from the broad inventive concept thereof. It is to be understood, therefore, that the subject disclosure is not limited to the particular exemplary embodiments disclosed, but it is intended to cover modifications within the spirit and scope of the subject disclosure as disclosed above.

I/we claim:

1. A cooking device, comprising:
an aroma generator, the aroma generator including
a reservoir,
an engine operatively connected to the reservoir,
a fan operatively connected to the reservoir atop the engine, wherein the engine is configured to power the fan, the fan configured to direct the mist throughout and out of the reservoir, and
a piezoelectric transducer, the piezoelectric transducer located within the reservoir on a bottom side of the reservoir;
an aroma needle configured to draw a liquid into the reservoir, wherein the piezoelectric transducer is configured to generate a mist from the liquid as an electric current is applied;
a housing operatively connected to the aroma generator, the housing including
an upper electric motor operatively connected to the aroma generator,
a base plate operatively connected to the upper electric motor,
a plurality of perforation needles mounted on the base plate,
an upper perforation plate, the upper perforated plate having a plurality of apertures,
an upper grilling plate below the upper perforation plate,
a pellet, the pellet located in between the upper perforation plate and the upper grilling plate, and
a lower grilling plate located below the pellet; and
a controller, the controller including a processor and a display,
wherein the upper perforation plate, the upper grilling plate, and the lower grilling plate have a similar shape.

2. The cooking device of claim 1, wherein the aroma needle further including a sleeve, the sleeve configured to circumscribe the aroma needle.

3. The cooking device of claim 2, wherein a diameter of the sleeve is larger than a diameter of the aroma needle.

4. The cooking device of claim 2, further including a gap between the sleeve and the aroma needle.

5. The cooking device of claim 2, wherein the sleeve is configured as a drive mechanism to biase the base plate in a direction towards the upper perforated plate.

6. The cooking device of claim 1, wherein the base plate further includes a central through hole.

7. The cooking device of claim 1, wherein the upper grilling plate further includes a plurality of recesses, the plurality of recesses of the upper grilling plate being coaxial with the longitudinal axis of each of the plurality of perforation needles.

8. The cooking device of claim 1, wherein the pellet includes an aroma pellet and a flavor pellet, the aroma pellet placed within a recess of the flavor pellet.

9. The cooking device of claim 1, wherein the upper perforation plate, the upper grilling plate, and the lower grilling plate have one of a rectangular or circular shape.

10. The cooking device of claim 1, wherein the aroma generator is operatively connected to an upper electric motor.

11. The cooking device of claim 1, wherein the aroma needle extends from the aroma generator through the base plate and provides fluid communication from a distal end of the aroma needle to the reservoir.

12. A method for cooking a food item, the method comprising:
receiving a food item on a first tray of a cooking device, and a pellet on a second tray located above the first tray;
setting a cooking parameter for the cooking device;
lowering an aroma needle from an original position to penetrate the pellet and retrieve a content within the pellet towards a reservoir of an aroma generator located on the cooking device;
heating the retrieved content in the reservoir to generate a mist, and releasing the generated mist to an area outside of the cooking device while retaining a portion of the mist within the reservoir;
lowering a plurality perforation needles and a sleeve operatively connected to a base plate to penetrate the pellet and the food item;
discharging a flavoring from the pellet to the food item via a plurality of through holes located a length of each of the plurality of perforation needles;
cooking and texturizing the food item based on the set parameter; and
retracting the aroma needle and plurality of perforation needles to the original position.

13. The method of claim 12, wherein the texturizing is performed by rotating a lower grilling plate configured to hold the first tray holding the food item while alternately retracting and reinserting the plurality of perforation needles out of and into the food item by alternately raising and lowering the plurality of perforation needles.

14. The method of claim 12, wherein the placing of the food item on the second tray and the placing of the pellet on the first tray include
moving a first tray and a second tray from a first position within a housing of a cooking device to a second position spaced laterally from the housing,
placing the food item on the second tray and placing the food item on the first tray while the second tray and the first tray are at the second position, and
moving the first tray and the second tray from the second position back to the first position.

15. A non-transitory computer readable medium having stored thereon instructions for causing a processing circuitry to perform a process, the process comprising:
receiving a food item on a first tray of a cooking device, and a pellet on a second tray located above the first tray;
setting a cooking parameter for the cooking device;
lowering an aroma needle from an original position to penetrate the pellet and retrieve a content within the pellet towards a reservoir of an aroma generator located on the cooking device;
heating the retrieved content in the reservoir to generate a mist, and releasing the generated mist to an area outside of the cooking device while retaining a portion of the mist within the reservoir;
lowering a plurality perforation needles and a sleeve operatively connected to a base plate to penetrate the pellet and the food item;
discharging a flavoring from the pellet to the food item via a plurality of through holes located a length of each of the plurality of perforation needles;
cooking and texturizing the food item based on the set parameter; and
retracting the aroma needle and plurality of perforation needles to the original position.
